(19) United States
(12) Patent Application Publication
(10) Pub. No.: US 2025/0280982 A1
(43) Pub. Date: Sep. 11, 2025

(54) ANTI-FATIGUE GEL GROUND MAT BASED ON RECYCLED SPONGE

(71) Applicant: JIANGXIN(ZHEJIANG) ECO HOME TECHNOLOGY CO.,LTD, JIAXING (CN)

(72) Inventor: FENG CAO, SHANGHAI (CN)

(21) Appl. No.: 19/022,206

(22) Filed: Jan. 15, 2025

Related U.S. Application Data
(63) Continuation of application No. PCT/CN2024/085789, filed on Apr. 3, 2024.

(30) Foreign Application Priority Data
Mar. 5, 2024 (CN) 202410249302.6

(51) Int. Cl. A47G 27/02; B32B 3/04; B32B 5/02; B32B 5/18; B32B 7/12; B32B 27/08; B32B 27/30; B32B 27/40; B32B 37/06; B32B 37/15; B32B 38/00

(52) U.S. Cl. CPC A47G 27/0231; B32B 3/04; B32B 5/024; B32B 5/18; B32B 7/12; B32B 27/08; B32B 27/304; B32B 27/40; B32B 37/06; B32B 37/153; B32B 38/0012; B32B 38/164; B32B 2038/0024; B32B 2038/0076; B32B 2260/025; B32B 2260/046; B32B 2266/0207; B32B 2305/02; B32B 2305/188; B32B 2305/70; B32B 2305/72; B32B 2307/744; B32B 2309/02; B32B 2309/04; B32B 2319/00; B32B 2327/06; B32B 2375/00; B32B 2471/04

(57) ABSTRACT

An anti-fatigue gel ground mat based on recycled sponge is disclosed, which includes a ground mat body. A beveled edge structure is arranged around the ground mat body. The ground mat body includes a surface layer, a gel layer, a recycled sponge layer, and an anti-skid layer compounded together in sequence from top to bottom. The gel layer is polyurethane solid gel. By arranging the gel layer, when the user steps on the ground mat body, the surface of the ground mat body is naturally concave to realize fatigue resistance. By arranging the beveled edge structure, the user can be prevented from stumbling, so that the safety is improved. The polyurethane solid gel is extruded in the shape of a snake to a lower surface of the surface layer through extrusion equipment, so that the use level of the polyurethane solid gel can be effectively reduced.

### TECHNICAL FIELD

The present disclosure relates to the technical field of ground mats, and in particular, to an anti-fatigue gel ground mat based on recycled sponge.

### BACKGROUND

In a working or home office environment nowadays, a ground mat with a rebounding supporting force is commonly used to alleviate physical fatigue in a standing state, increase physical comfort, and improve work efficiency. This kind of product is usually designed in a common shape and structure, for example, a horizontal structure with uniform thickness, which can meet characteristics in most usage scenarios. The ground mat in the prior art is poor in wrapping and supporting properties, does not conform with the stress state of a standing posture of a long-standing population, and is weak in anti-fatigue characteristics.

Based on the above circumstance, the present disclosure provides an anti-fatigue gel ground mat based on recycled sponge, which can effectively solve the above problems.

### SUMMARY

An objective of the present disclosure is to provide an anti-fatigue gel ground mat based on recycled sponge. According to the anti-fatigue gel ground mat based on recycled sponge provided by the present disclosure, by arranging a gel layer, the ground mat plays a better role in wrapping and supporting a sole of a user, so that when the user steps on the ground mat body, the surface of the ground mat body is naturally concave to realize fatigue resistance. By arranging a beveled edge structure around the ground mat body, the user can be prevented from stumbling, so that the safety is improved.

The present disclosure is implemented by the following technical solution.

An anti-fatigue gel ground mat based on recycled sponge includes a ground mat body. A beveled edge structure is arranged around the ground mat body, and an angle of a chamfered angle is 20-80°. The ground mat body includes a surface layer, a gel layer, a recycled sponge layer, and an anti-skid layer compounded together in sequence from top to bottom. The gel layer is polyurethane solid gel.

According to the above technical solution, as a further preferred technical solution of the above technical solution, a material of the surface layer is any one of PU leather, PVC leather, and a woven fabric.

According to the above technical solution, as a further preferred technical solution of the above technical solution, the polyurethane solid gel is extruded in the shape of a snake to a lower surface of the surface layer through extrusion equipment.

According to the above technical solution, as a further preferred technical solution of the above technical solution, the recycled sponge layer is formed by mixing smashed recycled sponge with cloth and/or recycled pure sponge with glue and drying the same.

According to the above technical solution, as a further preferred technical solution of the above technical solution, a material of the anti-skid layer is foamed rubber or SBR rubber.

According to the above technical solution, as a further preferred technical solution of the above technical solution, the smashed recycled sponge with cloth and/or recycled pure sponge are loaded into a cavity, mixed with glue, and then heated and pressurized for curing, and moreover, the gel layer and the anti-skid layer are respectively glued to upper and lower surfaces.

According to the above technical solution, as a further preferred technical solution of the above technical solution, the recycled sponge with cloth and/or recycled pure sponge are smashed to a particle size of 5-25 meshes, the glue is polyurethane glue, the use level of the glue is 2%-10% by weight of the recycled sponge, the mixing and stirring temperature is 10-30° C., and the stirring time is 10-30 min.

According to the above technical solution, as a further preferred technical solution of the above technical solution, the smashed recycled sponge with cloth and/or recycled pure sponge are subjected to a deironing step first, and the deironing step includes deironing by magnetic separation and/or vertical centrifugal deironing.

According to the above technical solution, as a further preferred technical solution of the above technical solution, the surface layer, the gel layer, the recycled sponge layer, and the anti-skid layer are formed by assembling upper and lower dies and heating and curing the dies, the temperature of the upper die is 55-90° C., the temperature of the lower die is 95-135° C., and the curing time is 2-15 min.

Compared with the prior art, the present disclosure has the following advantages and beneficial effects:

1. By arranging the gel layer, the ground mat plays a better role in wrapping and supporting a sole of a user, so that when the user steps on the ground mat body, the surface of the ground mat body is naturally concave to realize fatigue resistance.

2. By arranging the beveled edge structure around the ground mat body, the user can be prevented from stumbling, so that the safety is improved.

3. The polyurethane solid gel is extruded in the shape of a snake to the lower surface of the surface layer through the extrusion equipment, so that the use level of the polyurethane solid gel can be effectively reduced, and thus, the production cost is reduced.

### BRIEF DESCRIPTION OF FIGURES

FIG. 1 is a schematic longitudinal sectional diagram of the present disclosure.

### DETAILED DESCRIPTION

In order to enable persons skilled in the art to better understand the technical solutions of the present disclosure, preferred implementations of the present disclosure will be described in detail below in conjunction with specific embodiments. It should be understood that the drawings are merely used for exemplary description and are not construed as limitation to the patent. In order to better describe the embodiments, some parts in the drawings will be omitted, amplified or lessened and the drawings do not represent the dimensions of actual products. Persons skilled in the art can understand that some known structures and description thereof in the drawings may be omitted. The described position relationships in the drawings are merely used for exemplary description and cannot be construed as limitations to the patent.

The technical features described in the present disclosure, unless otherwise specified, all are purchased from conventional commercial routes or prepared by conventional methods. Specific structures, working principles and control modes, spatial arrangement modes which may be involved are conventionally selected in the art and should not be regarded as innovation points of the present disclosure. Persons skilled in the art may understand that the patent for invention is not further described in detail specifically.

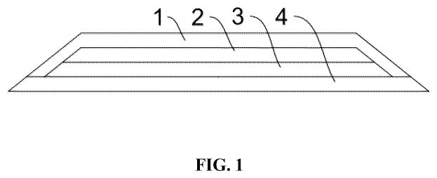

As shown in FIG. 1, an anti-fatigue gel ground mat based on recycled sponge includes a ground mat body. A beveled edge structure is arranged around the ground mat body, and an angle of a chamfered angle is 20-80°. The ground mat body includes a surface layer 1, a gel layer 2, a recycled sponge layer 3, and an anti-skid layer 4 compounded together in sequence from top to bottom. The gel layer 2 is polyurethane solid gel.

According to the present disclosure, by arranging the gel layer 2, the ground mat plays a better role in wrapping and supporting a sole of a user, so that when the user steps on the ground mat body, the surface of the ground mat body is naturally concave to realize fatigue resistance. By arranging the beveled edge structure around the ground mat body, the user can be prevented from stumbling, so that the safety is improved.

Further, in another embodiment, a material of the surface layer 1 is any one of PU leather, PVC leather, and a woven fabric.

Further, in another embodiment, the polyurethane solid gel is extruded in the shape of a snake to a lower surface of the surface layer 1 through extrusion equipment. The polyurethane solid gel is extruded in the shape of a snake to the lower surface of the surface layer 1, so that the use level of the polyurethane solid gel can be effectively reduced, and thus, the production cost is reduced.

Further, in another embodiment, the recycled sponge layer 3 is formed by mixing smashed recycled sponge with cloth and/or recycled pure sponge with glue and drying the same.

Further, in another embodiment, a material of the anti-skid layer 4 is foamed rubber or SBR rubber.

Further, in another embodiment, the smashed recycled sponge with cloth and/or recycled pure sponge are loaded into a cavity, mixed with glue, and then heated and pressurized for curing, and moreover, the gel layer 3 and the anti-skid layer 4 are respectively glued to upper and lower surfaces.

Further, in another embodiment, the recycled sponge with cloth and/or recycled pure sponge are smashed to a particle size of 5-25 meshes, the glue is polyurethane glue, the use level of the glue is 2%-10% by weight of the recycled sponge, the mixing and stirring temperature is 10-30° C., and the stirring time is 10-30 min.

Further, in another embodiment, the smashed recycled sponge with cloth and/or recycled pure sponge are subjected to a deironing step first, and the deironing step includes deironing by magnetic separation and/or vertical centrifugal deironing. Harmful components such as metallic iron, ferric oxide, iron-bearing minerals and the like in a blank are removed.

Further, in another embodiment, the surface layer 1, the gel layer 2, the recycled sponge layer 3, and the anti-skid layer 4 are formed by assembling upper and lower dies and heating and curing the dies, the temperature of the upper die is 55-90° C., the temperature of the lower die is 95-135° C., and the curing time is 2-15 min. By controlling the temperature of the upper die at 55-90° C., the polyurethane solid gel melts and uniformly and fully covers the lower surface of the surface layer 1; and moreover, the surface layer 1 and the gel layer 2 are compounded conveniently. By controlling the temperature of the lower die at 95-135° C., the recycled sponge layer 3 is cured and formed conveniently, and moreover, the recycled sponge layer, the gel layer 2, and the anti-skid layer 4 are connected conveniently in a compounded manner.

A preparation method of the anti-fatigue gel ground mat based on recycled sponge provided by the present disclosure includes the following steps:
S1, recycled sponge with cloth and/or recycled pure sponge are cleaned, airdried, and smashed to a particle size of 5-25 meshes;
S2, the smashed recycled sponge with cloth and/or recycled pure sponge, and polyurethane glue at a weight ratio of 10:1 are put in a container, and the mixture is stirred and mixed at room temperature for 10-30 min;
S3, polyurethane solid gel is extruded in the shape of a snake to a lower surface of the surface layer 1 through extrusion equipment;
S4, a prefabricated anti-skid layer is placed in a lower die, the mixed recycled sponge-glue mixture is placed on the anti-skid layer 4, then the surface layer 1 containing the polyurethane solid gel is covered, the upper die is heated to 55-90° C., the lower die is heated to 95-135° C., the upper and lower dies are assembled for insulating and curing for 2-15 min; and
S5, insulating is stopped, air cooling is performed, and the dies are opened to take out a product.

According to the description and drawings of the present disclosure, persons skilled in the art easily manufacture or use the anti-fatigue gel ground mat based on recycled sponge provided by the present disclosure, and can achieve positive effects recorded in the present disclosure.

In the present disclosure, unless otherwise specified, azimuthal or positional relations indicated by terms “length”, “width”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the azimuthal or positional relations shown in the drawings, which are only for ease of description of the present disclosure and for simplicity of description, and are not intended to indicate or imply that the referenced device or element needs to have a particular azimuth and be constructed and operative in a particular azimuth, and thus, the terms used in the present disclosure to describe azimuth or position relations are illustrative only, and may not be construed as a limitation on the patent, and persons of ordinary skill in the art may understand specific meanings of the above terms according to specific cases with reference to the accompanying drawings.

In the present disclosure, unless otherwise expressly specified and defined, the terms “arranging”, “connecting”, and “connection” should be understood in a broad sense, for example, they may be a fixed connection, a detachable connection, or an integrated connection; and may be a direct connection, or an indirect connection via an intermediate medium, or communication inside two elements. For persons of ordinary skill in the art, the specific meanings of the above terms in the present disclosure could be understood according to specific circumstances.

The above is merely a preferred embodiment of the present disclosure, rather than a limitation to the present disclosure in any form. Any simple modifications and equivalent changes made on the above embodiments based on the technical essence of the present disclosure all should fall within the protection scope of the present disclosure.

What is claimed is:

1. An anti-fatigue gel ground mat based on recycled sponge, comprising a ground mat body, wherein a beveled edge structure is arranged around the ground mat body, and an angle of a chamfered angle is 20-80°; the ground mat body comprises a surface layer, a gel layer, a recycled sponge layer, and an anti-skid layer compounded together in sequence from top to bottom; and the gel layer is polyurethane solid gel.

2. The anti-fatigue gel ground mat based on recycled sponge according to claim 1, wherein a material of the surface layer is any one of PU leather, PVC leather, and a woven fabric.

3. The anti-fatigue gel ground mat based on recycled sponge according to claim 1, wherein the polyurethane solid gel is extruded in the shape of a snake to a lower surface of the surface layer through extrusion equipment.

4. The anti-fatigue gel ground mat based on recycled sponge according to claim 1, wherein the recycled sponge layer is formed by mixing smashed recycled sponge with cloth and/or recycled pure sponge with glue and drying the same.

5. The anti-fatigue gel ground mat based on recycled sponge according to claim 1, wherein a material of the anti-skid layer is foamed rubber or SBR rubber.

6. The anti-fatigue gel ground mat based on recycled sponge according to claim 4, wherein the smashed recycled sponge with cloth and/or recycled pure sponge are loaded into a cavity, mixed with glue, and then heated and pressurized for curing, and moreover, the gel layer and the anti-skid layer are respectively glued to upper and lower surfaces.

7. The anti-fatigue gel ground mat based on recycled sponge according to claim 6, wherein the recycled sponge with cloth and/or recycled pure sponge are smashed to a particle size of 5-25 meshes, the glue is polyurethane glue, the use level of the glue is 2%-10% by weight of the recycled sponge, the mixing and stirring temperature is 10-30° C., and the stirring time is 10-30 min.

8. The anti-fatigue gel ground mat based on recycled sponge according to claim 6, wherein the smashed recycled sponge with cloth and/or recycled pure sponge are subjected to a deironing step first, and the deironing step comprises deironing by magnetic separation and/or vertical centrifugal deironing.

9. The anti-fatigue gel ground mat based on recycled sponge according to claim 1, wherein the surface layer, the gel layer, the recycled sponge layer, and the anti-skid layer are formed by assembling upper and lower dies and heating and curing the dies, the temperature of the upper die is 55-90° C., the temperature of the lower die is 95-135° C., and the curing time is 2-15 min.
